(19) United States
(12) Patent Application Publication
(10) Pub. No.: US 2008/0036383 A1
(43) Pub. Date: Feb. 14, 2008

(54) Structure of fluorescent lamp

(76) Inventor: Ran-Jin Lin, Hsinchu (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 11/501,614

(22) Filed: Aug. 9, 2006

(51) Int. Cl. H01J 1/62; H01J 61/30; H01J 63/04; H01J 17/16

(52) U.S. Cl. 313/634; 313/635; 313/489

(57) ABSTRACT

A structure of fluorescent lamp, which includes a sealed tube, electrode sets, and a passive luminous coating layer or a passive luminous body, is provided. The sealed tube is filled with a glow discharge medium, and electrode sets are assembled on two ends of the sealed tube to be contacted with the glow discharge medium and provide an electrical power to generate the electrical-glow-discharge of the glow discharge medium for emitting a glow-discharge light. The passive luminous coating layer or the passive luminous body is disposed on an outer surface of the sealed tube. The passive luminous coating layer or the passive luminous body absorbs the glow-discharge light to emit a luminous light with corresponding wavelength without being contacted with the glow discharge medium. Thus the interaction between glow discharge medium in the sealed tube and the luminous material is prevented.

### BACKGROUND OF THE INVENTION

1. Field of Invention

The present invention relates to a fluorescent lamp. More particularly, the present invention relates to a structure of a fluorescent lamp for illuminating, promoting photochemical reactions, or heating.

2. Related Art

Referring to FIG. 1, a structure of a fluorescent lamp in the prior art is shown. The fluorescent lamp 10 includes the sealed glass tube 11 with a gas duct 111, electrode sets 12, phosphor layer 13 and the glow-discharge medium. The glow-discharge medium is composed of inert gases, such as Argon, Neon, or a mixture thereof, and mercury droplets (or mercury alloys) with an appropriate amount inside the sealed tube 11. After filling the glow-discharge medium, the air duct 111 is then sealed. The inner wall of the sealed tube 11 is coated with short-afterglow luminous material such as monochromatic phosphor powder 13 (for example, red, green, or blue), polychromatic phosphor powder 13 (such as yellow, cyan, orange, or white), or a mixture of the red, green and blue phosphor powder 13 in various proportions. Here, the short-afterglow luminous material is a phosphor whose time period to decay the luminous intensity to 50% is shorter than one minute after the absence of the glow-discharge light.

When the electrode sets 12 at two ends of the sealed tube 11 are charged, the electrons released from the electrodes are accelerated from one end of the sealed tube 11 to the other end thereof under the effect of the electrical field. During the travel of the electrons, the atoms of mercury are excited to an excited state due to the collision between electrons and mercury atoms. The excited mercury atoms return to the ground state accompanying with the emission of the light. This glow-discharge light is mainly composed light with wavelength of 185 nm (about 5% of total emission light) and 253.7 nm (about 60% of total emission light). By choosing the suitable phosphor material, the visible light with wavelength of 380-750 nm can be emitted by the phosphor powder 13, which is excited to the excited state by absorbing the glow-discharge light.

Now, the fluorescent lamps that emit the visible light due to the transition from the excited state to the ground state of the phosphor powder 13 by absorbing the exciting light of the gas discharge are widely used in homes, offices and outdoors.

It has been found that 99.8% of the mercury filled in the sealed tube 11 will be bonded with the phosphor powder 13 in a damaged fluorescent lamp of a long-time use. This is due to the chemical reaction between the mercury vapor and the phosphor powder 13 on the inner wall of the sealed tube 11 with enhancement of high-energy electrons bombardment. In the adverse conditions, the stable mercury compounds with the features of low vapor pressure of the mercury, no light emission and low transmittance of visible light may be formed on the surface of the phosphor powder 13. The performance and life time of the fluorescent lamp will be greatly affected. The recycling and pollution elimination on the environments for the used lamps will become more difficult. Specifically, there are several disadvantages for the conventional lamp whose phosphor powder 13 are coated on the inner wall of the sealed tube 11. Firstly, the amount of vaporizable mercury decreases with operation time. Excess amount of mercury is required during filling the glow-discharge medium into the sealed tube 11. Secondly, the luminous intensity of the lamp is variable with time. The luminous intensity of the lamp is strongly dependent on the vapor pressure of the mercury and total pressure inside the sealed tube 11, which strongly vary with operation time due to chemical reaction between mercury vapor and phosphor powder and degradation of the phosphor powder. Thirdly, recycling of the used fluorescent lamp becomes difficult. It is difficult to separate the mercury from the stable mercury compounds due to interaction between mercury vapor and phosphor powder. Fourthly, there is mercury pollution on environment due to the waste of the fluorescent lamp.

Additionally, the phosphor powder 13 of the current fluorescent lamps have short afterglow, which means that the phosphor powder 13 do not emit light after the glow-discharge light source is absent. To maintain the luminous intensity of a fluorescent lamp, the electrical power has to be continuously supplied. Thus, the temperature of the phosphor powder 13 coated on the inner wall of the sealed tube 11 will rise to high temperature with the operating time of the fluorescent lamp 10. The phosphor powder 13 will decompose into material of emitting no light and form the mercury compounds that emit no light. Therefore, the operating current (or power) of the fluorescent lamps is limited.

Sodium lamps are often used as outdoor street lamps. These lamps have a similar structure as that of the conventional mercury fluorescent lamps. The discharge medium is composed of inert gases (such as a mixture of Neon and Argon) sodium-containing substances, and mercury-containing substances inside the sealed tube. There is no phosphor powder on the wall of the sealed tube. The sodium lamps are characterized by the highest luminescence efficiency among all gas discharge lamps. The light emitted from the sodium lamps has characteristic line spectra of 589.0 nm and 589.6 nm. The color rendering of the sodium lamps is very poor. In addition, the wall or inside temperature of the sealed tube is high to maintain the enough vapor pressure of sodium. Presently, the typical temperature is at least 260° C. This high operation temperature will result in the more power consumption due to the heat radiation loss.

Conventionally, the infrared light is often used for drying substances, sauna, heating the substances. The infrared light is generated from the surface of the objects with high temperature. As for near-infrared light sources with the emission wavelength of 900-2000 nm, the typical surface temperature of the objects is about 2200° C. As for mid-infrared light sources (with the wavelength of 2000-4000 nm) and far-infrared light sources (with the wavelength over 4000 nm), the surface temperature of the heated objects must achieve 1030° C. and 440° C. respectively. The disadvantage of these infrared light sources is high operation temperature, which induces a large power consumption and high probability of injury to the users without suitable protection. Additionally, it is hard to independently control the luminous intensity and wavelength, which depend on the surface temperature of the object.

Furthermore, the light emitted from the gas discharge of conventional mercury-containing glow-discharge medium is mainly composed of 253.7 nm and 185 nm lights if no phosphor powder is coated on the inner wall of the sealed tube. The human skin will be damaged under the irradiation of 253.7 nm and 185 nm lights due to their high energy. For promoting bio-reactions that are beneficial to human health by light irradiation, as for the synthesis of vitamin D in human skin, the suitable wavelength of the light irradiated on the human skin is in the ranges of 280 nm to 400 nm. Therefore, it is necessary to transfer the short-wavelength 253.7 nm and 185 nm to the ultraviolet light with longer wavelength. For example, the ultraviolet-emission materials such as GdBO₃:Pr, SrB₄O₇:Eu, or (Sr, Mg)₂P₂O₇:Eu, emit ultraviolet light with wavelength 280-400 nm after being excited by the 253 nm or shorter wavelength.

### SUMMARY OF THE INVENTION

In view of aforementioned problems, the object of the present invention is to provide a structure of a fluorescent lamp, in which the passive luminous material is disposed outside the sealed tube for gas discharge, so as to eliminate the problems that the passive luminous material is disposed inside the sealed tube.

In order to achieve the object, a structure of a fluorescent lamp, which includes a sealed tube, at least a pair of electrode sets, passive luminous material, and at least a protective layer, is provided. The seal tube is filled with glow discharge medium and a wall of the sealed tube can be transmitted by a glow-discharge light emitted by the electrical-glow-discharge of the glow discharge medium. The electrode sets are assembled on two ends of the sealed tube and contacted with the glow discharge medium; thereby the electrode sets provide an electrical power to generate the electrical-glow-discharge of the glow discharge medium for emitting a glow-discharge light. The passive luminous material is coated on an outer surface of the sealed tube to form a passive luminous layer, wherein the passive luminous layer absorbs the glow-discharge light emitted by the glow discharge medium to emit a luminescence light with corresponding wavelength. The protective layer is coated on the passive luminous layer, wherein the luminescence light emitted by the passive luminous layer can transmit the protection layer.

In another embodiment of the present invention, a structure of a fluorescent lamp is provided, which includes a sealed tube, at least a pair of electrode sets, passive luminous material, and at least a protective layer. The seal tube is filled with a glow discharge medium and a wall of the sealed tube can be transmitted by a glow-discharge light emitted by the electrical-glow-discharge of the glow discharge medium. The electrode sets are assembled on two ends of the sealed tube and contacted with the glow discharge medium; thereby the electrode sets provide an electrical power to generate the electrical-glow-discharge of the glow discharge medium for emitting a glow-discharge light. The passive luminous body is disposed outside the sealed tube, absorbs the glow-discharge light to emit a luminescence light with corresponding wavelength.

According to the structure of the fluorescent lamp of the present invention, when the passive luminous material outside the sealed tube is a long-afterglow luminous material, an on-off control circuit can be further used to connect the pair of electrode set and a power source for turning on and turning off the electrical power with a preset program. The on-off control circuit can turns on the electrical power until the passive luminous coating layer or luminous body fully absorbs and stores the light energy, and then turns off the electrical power after the luminous intensity of the passive luminous coating layer or luminous body decays to the lowest luminance required, and turns on the electrical power again. By repeating the steps described above, the power consumption can be reduced. Moreover, after the glow discharge light source is absent, the excited long-afterglow luminous material will continue to emit light for over 12 hours until the light becomes invisible to people. Therefore, this type of fluorescent lamps can be used as emergency illumination for evacuating persons when the power is accidentally cut off, and the emergency illuminator using battery cells are not required. Because there is a specific time period of light irradiation for most fluorescent lamps that emit the infrared light or ultraviolet light, the similar on-off control circuit can also be used to achieve these special purposes.

The implementation of the present invention can achieve the following advantages:

1. The phosphor powder can be protected from being affected by the plasma temperature, electron and ion impact, and the material degradation of the phosphor powder can be prevented.

2. The phosphor powder is protected from directly contacting with the mercury vapor and thus mercury compounds that are difficult to be vaporized are not generated.

3. The consumption of the mercury material is reduced, and the problem that the luminescence efficiency of visible light decreases due to the material degradation of the phosphor powder is prevented.

4. The amount of the mercury filled in can be estimated precisely during the manufacturing of the fluorescent lamps, and thus the amount of the mercury used is reduced.

5. The passive luminous material can almost be a non-consumable material that can be recycled and reused.

6. When the tube of the fluorescent lamp is out of the order, the recycling of the lamp tube is easy.

7. The recovery rate of the damaged fluorescent lamps will increase because the recovery of mercury is easy and expensive rare-earth phosphors are not contaminated by mercury.

8. The environmental problem caused by the waste lamps can be overcome, and the resource of relevant materials can be reused effectively.

9. The power consumption of the fluorescent lamps can be reduced.

10. The emergency illumination can be provided when the power is accidentally cut off.

The features and examples of the present invention are illustrated with reference to the preferred embodiments and the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 shows the structure of a conventional fluorescent lamp.

FIG. 2 is a sectional view of the structure of fluorescent lamp of a first embodiment of the present invention.

FIG. 3A is a sectional view of the structure of fluorescent lamp having a passive luminous body with a supporting tube of a second embodiment of the present invention.

FIG. 3B is a sectional view of the structure of fluorescent lamp having a passive luminous body with a supporting plate of a second embodiment of the present invention.

FIG. 4A is a sectional view of the structure of fluorescent lamp having a luminous tube of a second embodiment of the present invention.

FIG. 4B is a sectional view of the structure of fluorescent lamp having a luminous plate of a second embodiment of the present invention.

FIG. 5 is a sectional view of the structure of fluorescent lamp having support for supporting a luminous plate and the sealed tube of a second embodiment of the present invention.

FIG. 6 is an application of the structures of fluorescent lamp using an on-off control circuit and the light sensor according to embodiments of the present invention.

FIG. 7 is a flow chart of the method for enabling the passive luminous material to illuminate.

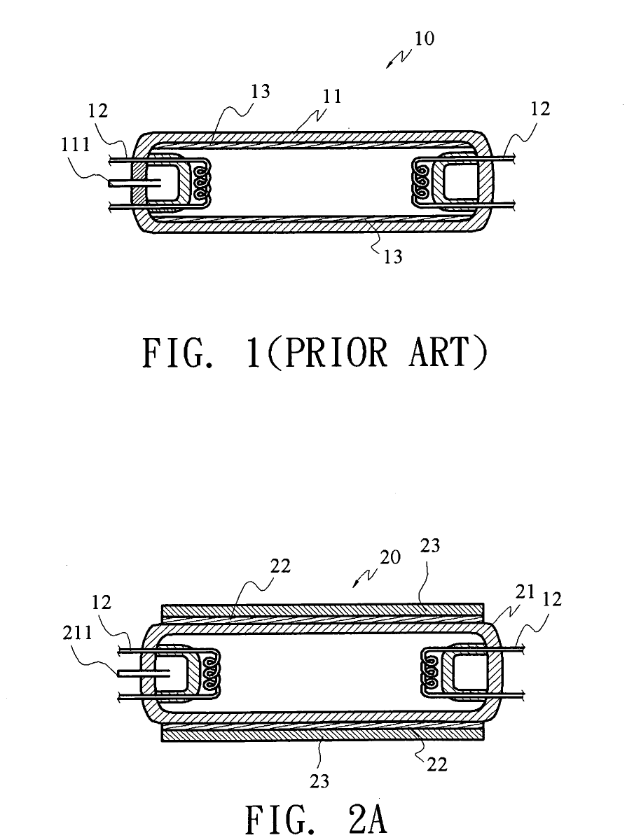

### DETAILED DESCRIPTION OF THE INVENTION

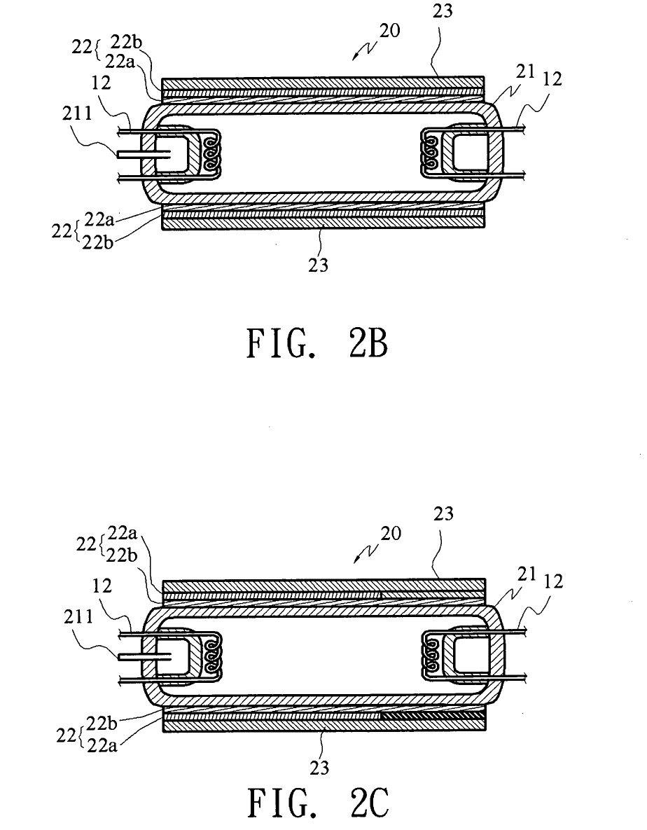

Referring to FIG. 2A, a fluorescent lamp 20 of the first embodiment is provided, which includes a sealed tube 21, a pair of electrode sets 12, a passive luminous material 22, and a protective layer 23, in which the passive luminous material 22 is coated on the outer surface of the sealed tube 21 to form a passive luminous coating layer.

At least one end of the sealed tube 21 has an air duct 211 formed by glass, through which the air is evacuated from the sealed tube 21 to a desired vacuum and then the sealed tube 21 is filled with a glow discharge medium, for example, a glow discharge medium of inert gases (Argon, Neon, Krypton, and mixed gas thereof) and mercury. The mercury can be pure mercury, a mercury-containing substance, or a mixture of mercury and metal halides, such that a glow-discharge light with corresponding wavelengths, for example, ultraviolet light, visible light, infrared light or mixture thereof is emitted by the glow discharge medium when the glow discharge medium is excited. Alternatively, pure sodium or sodium-containing substances can be further added into the glow discharge medium. Then the outward end of the air duct 211 is sealed, such that the sealed tube 21 is also sealed. In addition, the sealed tube 21 is formed by a material that can be transmitted by the glow-discharge light emitted by the electrical-glow-discharge of the glow discharge medium, for example, glass.

The electrode sets 12 are assembled on two ends of the sealed tube 21, and are contacted with the glow discharge medium. When an electrical voltage is applied to the electrode sets 12, the electrode sets 12 provide electrical power to the glow discharge medium to generate the electrical-glow-discharge of the glow discharge medium for emitting the glow discharge light.

The passive luminous material 22 is coated on the outer surface of the sealed tube 21 to form a passive luminous coating layer, wherein the passive luminous layer absorbs the glow-discharge light emitted by the glow discharge medium to emit a luminescence light with corresponding wavelength. In particular, the passive luminous material 22 can be mixed with a binder such as glass powder or polymers, and the mixture is then coated by brushing or spraying, etc. on the outer surface of the sealed tube 21.

The passive luminous material 22 can be visible-emitted-material that emits visible light by absorbing the glow-discharge light, such as a short-afterglow luminous material, a long-afterglow luminous material, or the mixture thereof in any proportion. Here, the long-afterglow luminous material is a passive luminous material whose time period to decay the luminous intensity to 50% is longer than one minute after the absence of the glow discharge light. On the contrary, if the time period is less than 1 minute, the material is the short-afterglow luminous material.

In specific, the short-afterglow luminous material can be short-afterglow phosphor powder, wherein the monochromatic phosphor includes red Y203:Eu, green Ce_{0.67}Tb_{0.33}MgAl₁₁O₁₉ or Zn₂SiO₄:Mn, blue Sr₅(PO₄)₃Cl:Eu or BaMg₂Al₁₆O₂₇:Eu, and polychromatic phosphor include yellow, cyan, orange, white (Ca₅(PO4)₃F:Sb³⁺,Mn²⁺), etc., or a mixture of monochromatic red, green, and blue phosphor. The long-afterglow luminous material can be long-afterglow phosphor powder, wherein the monochromatic phosphor includes red CaAl₂O₄:Eu, Nd, green SrAl₂O₄:Eu, Dy, blue Sr₄Al₁₄O₂₅:Eu, Dy, the polychromatic phosphor includes yellow, cyan, orange, white (CaAl₂O₄:Dy³⁺), etc., or a mixture of monochromatic red, green, and blue phosphor. The passive luminous materials 22 can be monochromatic materials, polychromatic materials, or a mixture of a plurality of monochromatic materials.

The passive luminous material 22 is coated on the outer surface of the sealed tube 22 by various methods, for example, stirring the phosphor powder, a solvent, and a binder into a paste, brushing or spraying the paste with an air gun onto the outer surface of the sealed tube 22, and then drying at 80° C. and baking at 200-400° C. to remove the solvent. The binder described above can be a polymer or glass powder, or a mixture thereof. In addition, a conductive layer which can be transmitted by the glow-discharge light of the glow discharge medium can be coated between the outer surface of the sealed tube 21 and the passive luminous coating layer in advance, for example, the conductive layer can be an oxide conductive layer with the thickness of 0.5-1 μm (indium tin oxide, zinc aluminum oxide, tin antimony oxide, or fluorine tin oxide), or an metal thin layer (Au, Ag, Ni or Al with the thickness of less than 30 nm). Then the phosphor powder is coated on the outer surface by the electrophoresis or electrostatic coating methods. Then, through a baking process, the solvent is removed, and the binder strength and optical transmittance are improved. The above-mentioned polymer material is a material that can be transmitted by visible light, for example, polyvinyl chloride (PVC), polycarbonate (PC), poly methylmethacrylate (PMMA), and polyurethane (PU), etc.

A protective layer 23 is further coated on the passive luminous coating layer formed by the passive luminous material 22, and the luminescence light emitted by the passive luminous coating layer formed by the passive luminous material 22 can transmit the protective layer 23, so as to enhance the transmittance of visible light, protect the passive luminous material 22 from peeling off due to external forces, and prevent the dust and grease contaminating the surface of the passive luminous material 22, which helps to keep the surface clean. The protective layer 23 of the embodiment can be formed by oxide conductors (such as indium tin oxide, zinc aluminum oxide, tin antimony oxide, or fluorine tin oxide), oxide nonconductors (such as magnesia), glass, or polymers (such as PVC, PC, PMMA, or PU), with a thickness of 0.5-5 μm. The polymers aforementioned can be polyvinyl chloride (PVC), poly methylmethacrylate (PMMA), polyurethane(PU), and the like.

When the protective layer 23 is formed by glass, the protective layer 23 can be formed by glass coatings (with pastes made of SnO—ZnO—P₂O₅ glass powder, solvent, and amyl acetate binder) or glass sol-gel which have a low softening point (lower than 60° C.) and are able to be transmitted by visible light. The passive luminous material 22 is coated first, then is coated with glass coatings, and finally is placed into the high-temperature oven for baking, thus forming the compact glass film to serve as the protective layer 23 to protect the passive luminous material 22. In addition, the thermal evaporation or ion sputtering methods can also be used to grow the glass protective layer 22 on the surface of the passive luminous material 22.

As the refractive index of the transparent oxide conductors, transparent oxide nonconductors, polymers, or glass is lower than that of the passive luminous material, the protective layer 23 formed by these materials can increase the transmittance of light.

Referring to FIG. 2B and FIG. 2C, in addition to luminous materials that emit visible light, the passive luminous material 22 can also be an infrared light-emitting material that emits infrared light by absorbing the glow-discharge light. Definitely, the passive luminous material 22 can also be a combination of visible light-emitting material and infrared light-emitting material, or the passive luminous material 22 can be formed with a visible light-emitting coating layer 22a by visible light-emitting material and an infrared light-emitting coating layer 22b by infrared light-emitting material stacking on each other. So that the passive luminous material 22 can emits light of the combination of visible light and infrared light. In such a combination of visible light-emitting material and infrared light-emitting material, the protective layer 23 has to be formed by material that is able to be transmitted by visible light and infrared light. The differences in FIG. 2B and FIG. 2C is that the infrared light-emitting coating layer 22b is completely coated on the outer surface of the visible light-emitting coating layer 22a in FIG. 2B, while the infrared light-emitting coating layer 22b is coated on part of the outer surface of the visible light-emitting coating layer 22a in FIG. 2C.

Referring to FIG. 2D, the passive luminous material 22 can also be an ultraviolet light-emitting material for absorbing the glow-discharge light with a wavelength of 253 nm to emit ultraviolet with wavelength of 280-400 nm. For example, the ultraviolet light-emitting material can be GdBO₃:Pr, SrB₄O7:Eu, (Sr, Mg)₂P₂O₇.

Furthermore, infrared light-emitting material, visible light-emitting material, and ultraviolet light-emitting material can be mixed to form a single passive luminous layer, or forming a visible light-emitting coating 22a, an infrared light-emitting coating layer 22b, and ultraviolet light-emitting coating layer 22c stacking on each other, for absorbing the glow-discharge light to emit a luminescence light of the combination of visible light, infrared light, and ultraviolet light. For increasing the transmittance of the mixing light (such as combination of visible light and infrared light, visible light and ultraviolet light, infrared light and ultraviolet light, or visible light, infrared light, and ultraviolet light), the protection layer 23 on the luminous material 22 sometimes is not used.

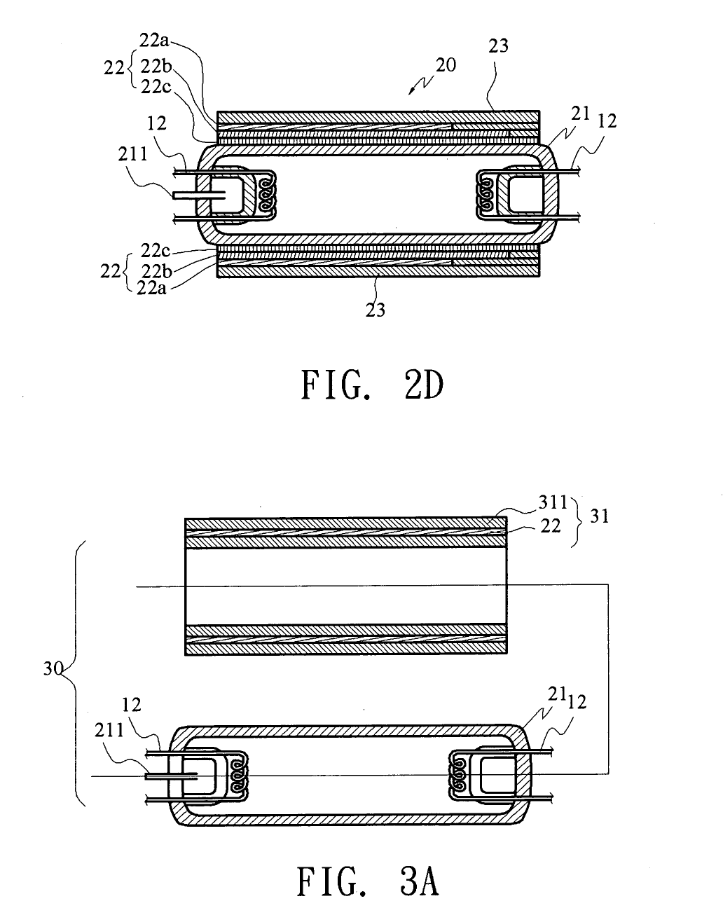

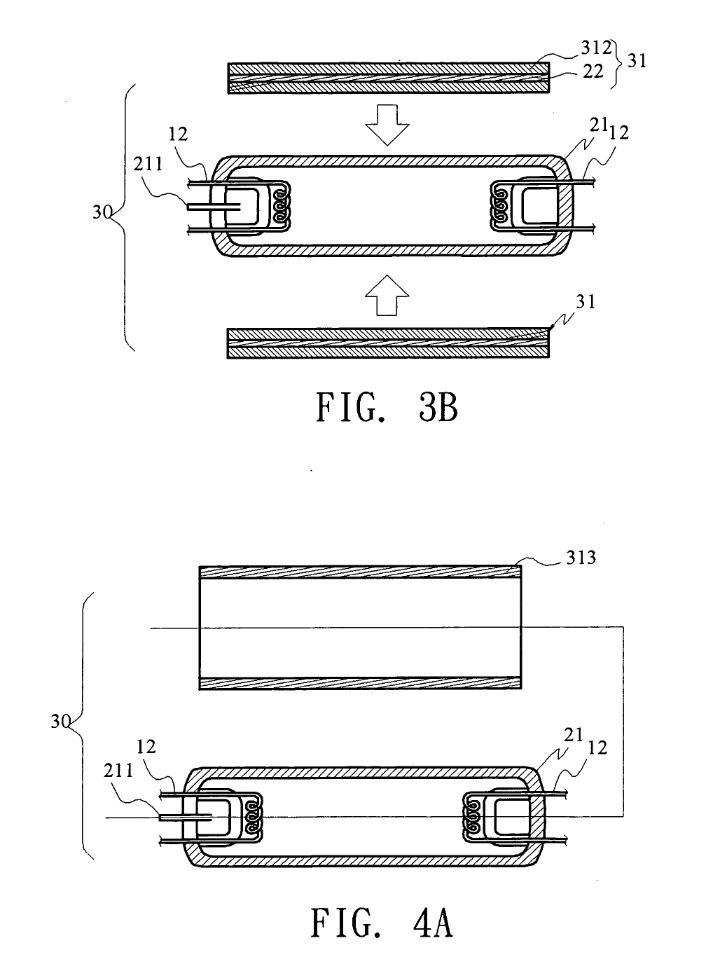

Referring to FIGS. 3A, 3B, 4A, 4B, 4C, 4D, and 5, a fluorescent lamp 10 of a second embodiment of the invention is provided, which includes a sealed tube 21, a pair of electrode sets 12, passive luminous body 31, and a support 40 for fixing the sealed tube 21 and the passive luminous body 31. In the second embodiment, the sealed tube 21 and the passive luminous body 31 of the structure of fluorescent lamp 30 are fabricated separately and then are assembled as a whole.

At least one end of the sealed tube 21 has an air duct 211 formed by glass, through which the air is evacuated from the sealed tube 21 to a desired vacuum and then the sealed tube 21 is filled with glow discharge medium, for example, a glow discharge medium of inert gases (Argon, Neon, Krypton, and mixed gas thereof) and mercury. The mercury can be pure mercury, or a mercury-containing substance, or a mixture of mercury and metal halides, such that a glow-discharge light with corresponding wavelengths, for example, ultraviolet light, visible light, or mixed light of ultraviolet light and visible light is emitted by the glow discharge medium when the glow discharge medium is excited. Then the outward end of the air duct 211 is sealed, such that the sealed tube 21 is the sealed. In addition, the sealed tube 21 is formed by a material that can be transmitted by the glow-discharge light emitted by the electrical-glow-discharge of the glow discharge medium, for example, glass.

The electrode sets 12 are assembled on two ends of the sealed tube 21, and are contacted with the glow discharge medium. When an electrical voltage is applied to the electrodes sets 12, the electrode sets 12 provide electrical power to the glow discharge medium to generate the electrical-glow-discharge of the glow discharge medium for emitting the glow discharge light.

Referring to FIGS. 3A and 3B, the passive luminous body 31 is disposed outside of the sealed tube 21. The passive luminous body 31 includes supporting body and the passive luminous material 22. In particular, the supporting body can be a supporting tube 311 or a supporting plate 312, and then the passive luminous material 22 is coated on the surface of the supporting body facing the sealed tube 21. The supporting body can be formed by materials that can be transmitted by the light emitted by the passive luminous material 22, such as glass, PC, PVC, transparent polyethylene (PE), and polypropylene. The supporting body can also be metal materials that are highly reflective and unable to be transmitted by light released by the passive luminous material 22, such as Ni, Al, stainless steel, Cu, and supporting materials with metal (such as Ni, Al, Au or Ag) film grown thereon, so as to enhance the luminous intensity of the passive luminous material 22.

The passive luminous material 22 is coated on surface of the supporting body by various methods, for example, stirring the fluorescent powder, a solvent, and a polymer binder into the paste, and brushing, dipping, or spraying the paste with an air gun, and then drying at 80° C. and baking at 200-400° C. to remove the solvent. The passive luminous material 22 can be a short-afterglow luminous material, a long-afterglow luminous material, or a mixture thereof.

In addition to passive luminous material 22 formed with a single layer that emits visible light, the passive luminous material 22 can also be an infrared light-emitting material that emits infrared light by absorbing visible light or ultraviolet, or an ultraviolet light-emitting material that emits ultraviolet with long wavelength of 280 nm-400 nm by absorbing ultraviolet with short wavelength of 253 nm or shorter. The passive luminous material 22 can also be combination of plural light-emitting materials for emitting combination light. Furthermore, the passive luminous material 22 can be formed with plural layers stacking on each other for emitting visible light, infrared light, ultraviolet, or the combination of visible light, infrared light and ultraviolet. The passive luminous material 22 can be coated on the outer surface of the supporting body as shown in FIGS. 3A and 3B, or be coated on the inner and outer surfaces at the same time.

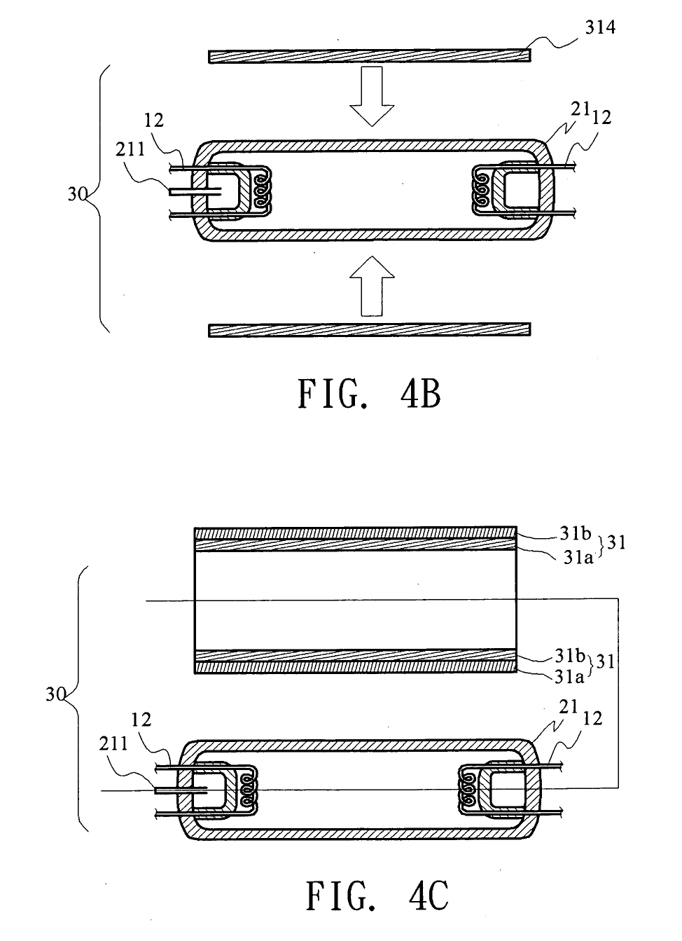

Referring to FIGS. 4A and 4B, the passive luminous body 31 can be a tube or a plate formed by a short-afterglow luminous material, a long-afterglow luminous material, or a mixture thereof, which is sintered at a high temperature. In specific, a luminous tube 313 or a luminous plate 314 can be formed by sintering a short-afterglow phosphor powder, a long-afterglow phosphor powder, or a mixture thereof at a temperature. The luminous tube 313 or a luminous plate 314 with a single layer can be formed by infrared light-emitting martial or ultraviolet light-emitting material that emits infrared light or emits ultraviolet light with wavelength of 280 nm-400 nm by absorbing ultraviolet light with wavelength of 253 nm. The luminous tube 313 or a luminous plate 314 with a single layer can also be formed by plural materials that emit combination light. Definitely, The luminous tube 313 or a luminous plate 314 can be formed with plural layers by different light-emitting materials, so that the luminous tube 313 or a luminous plate 314 can be excited to emit visible light, infrared light, ultraviolet light, combination of infrared light and visible light, combination of visible light and ultraviolet light, combination of infrared light and ultraviolet light, or combination of visible light, infrared light, and ultraviolet light.

Referring to FIGS. 4C and 4D, a passive luminous body 31 with plural layers is shown. Ultraviolet light with wavelength of 253 nm, emitted from the sealed tube 21 by gas discharge, is firstly absorbed by a visible light-emitting passive luminous body 31a in the first layer, and the visible light-emitting passive luminous body 31a is excited to emit visible light. The visible light is then absorbed by an infrared light-emitting passive luminous body 31b in the second layer, and infrared light-emitting passive luminous body 31b is excited to emit infrared light. If the visible light-emitting passive luminous body 31a is not completely covered by the infrared light-emitting passive luminous body 31b, a passive luminous body 31 with plural layers emits combination light of visible light and infrared light, as shown in FIG. 4D. According to the structure of the passive luminous body 31 with plural layers, passive luminous body 31 can be excited to emit visible light, infrared light, ultraviolet light, combination of infrared light and visible light, combination of visible light and ultraviolet light, combination of infrared light and ultraviolet light, or combination of visible light, infrared light, and ultraviolet light.

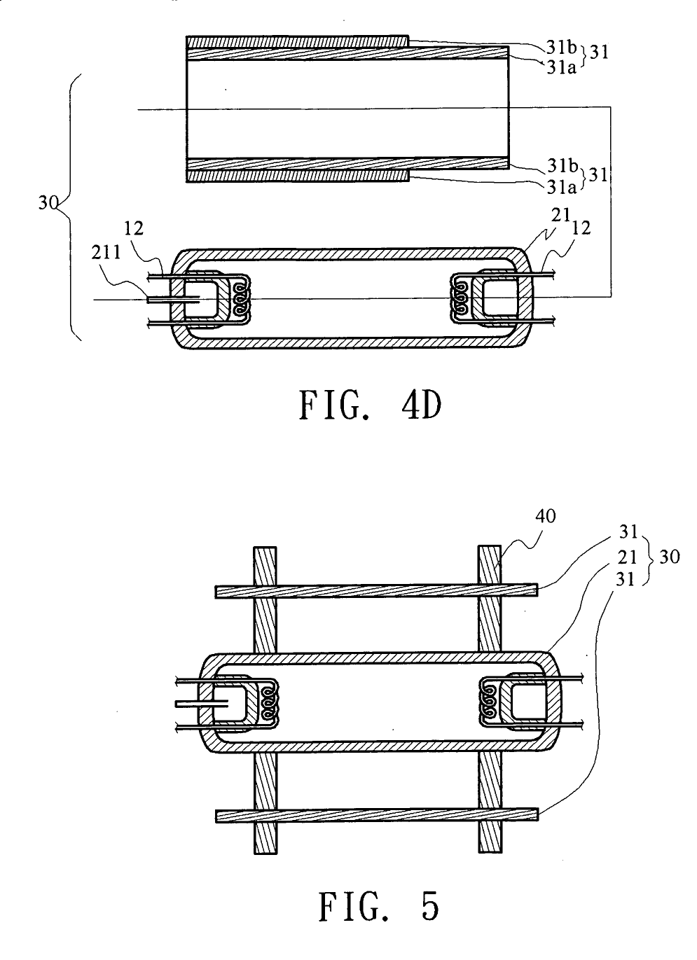

Referring to FIG. 5, in the structure of fluorescent lamp 30 of the embodiment, when the passive luminous body 31 is a plate, the sealed tube 21 is supported in the central part with a support 40. The passive luminous body 31 is supported with the support 40 to be fixed on the outer side of the sealed tube 21.

Conventionally, the luminous materials are made into powder, i.e., after the crystalline structure is achieved by sintering, the block materials are smashed and ground into fine powder. This process may cause defects to the luminous crystals, such as residual strains and micro cracks, which greatly reduce the luminescence efficiency. In addition, when the phosphor powder is formed subsequently, the power must be mixed with the solvent and the organic or inorganic binder and stirred into a paste, and then the paste is coated on the surface of a supporting body. The grinding during the mixing may damage the surface of the phosphor powder, and the subsequent heating process for removing the organic substance and drying the powder may change the oxidation state of the luminous center of the phosphor powder, thus reducing the luminescence efficiency.

Therefore, the present invention provides the luminous tube or luminous plate formed through sintering. The fabricating method involves evenly mixing the raw materials by the solid state method, the chemical co-precipitation method, or the sol-gel method, and forming the desired phase structure of the luminous powder through the calcining reaction, grinding the reaction products into fine powder, mixing the powder with appropriate polymer binder, forming the luminous tube or luminous plate through inject molding, and then obtaining the luminous tube or luminous plate through sintering in a high-temperature oven. As the luminous powder used is subjected to a high temperature (normally over 1300° C.) process, the luminous tube or luminous plate is characterized by stability and acid/alkali resistance. The luminous material naturally is a kind of ceramic material and has an appropriate strength, and thus it is a fine structural material. As for fluorescent lamps with specific light-emitting direction, if a small-size bulb-shaped or planar sealed tube 21 is used, a luminous plate for generating visible light is preferred. In addition to those similar to those of the luminous tube, the luminous plate can also be fabricated by the scraper method, the powder metallurgy method, or the slurry-casting method, and then sintered in the high-temperature oven.

In this embodiment, the sealed tube 21 and the passive luminous body 31 are fabricated separately, and then assembled to form the structure of fluorescent lamp 30. Thus, the cooling effect of the phosphor powder of the passive luminous body 31 increases, so the passive luminous body 31 formed by the phosphor material can be kept at a lower temperature during operation, which helps to improve the luminescence efficiency and stability of the passive luminous body 31. Furthermore, as the sealed tube 21 is shielded by the phosphor tube 313 from the air in the environment, the temperature of the tube wall of the sealed tube 21 can be easily kept stable, and is not affected by the flowing of the air in the environment, and thus the luminous intensity becomes more stable.

In order to improve the luminous intensity, the surface exposed to air of the phosphor tube 313 or phosphor plate 314 formed by the passive luminous material in this embodiment can be coated with a material which can be transmitted by the light emitted by the passive luminous material and has a refractive index lower than that of the passive luminous material. The suitable material are, for example, oxide conductors (such as indium-tin oxide, zinc-aluminum oxide, tin-antimony oxide, or fluorine-tin oxide), oxide nonconductors (such as magnesia), glass, or polymers, etc.

Common characteristics of the aforementioned embodiments will be described below. When the structures of fluorescent lamp 20, 30 of the aforementioned embodiments are used, the electrode sets 12 provide electrical power to the glow discharge medium, such that the glow discharge medium filled in the sealed tube 21 is excited to emit light. As the passive luminous layer 22 or the passive luminous body 31 absorbs the glow-discharge light to emit a visible light, such as monochromatic red, green, blue, or polychromatic yellow, cyan, orange, and white, thus can be used for illuminating.

When the passive luminous coating layer 22 or the passive luminous body 31 of the structures of fluorescent lamp 20, 30 are formed by the short-afterglow phosphor powder, the operating mode is the same as that of the conventional fluorescent lamp, i.e., continuously supplying power to the electrode sets 12. However, when the passive luminous coating layer 22 or the passive luminous body 31 of the fluorescent lamp structures 20, 30 is formed by the long afterglow phosphor powder or combined with the long afterglow phosphor powder, the operating mode is continuously or discontinuously supplying power. If the discontinuously supplying power, the power consumption can be reduced, and the temperature of the tube wall of the seal tube 21 can be reduced.

The long-afterglow luminous material described above can be a high-luminance Sr—Al—O family materials with long-afterglow. When the exciting light is absent, the Sr—Al—O family material can continuously emit light that is visible to human eyes for 12 hours, in which the luminance decays slowly with time.

The present invention combines the long afterglow material and the sealed tube 21 of the fluorescent lamp. By adding an appropriate power control circuit, the operating mode of the fluorescent lamp can be changed to be a discontinuous power supply, such that the power source of the electrode sets 12 is turned on or off at a predetermined time. That is, the power source is turned on at first, such that the glow discharge medium in the sealed tube 21 releases the exciting light, and the exciting light is then absorbed by the long-afterglow phosphor powder, coated on the outer wall of the sealed tube 21. A part of the excited phosphor powder returns to the ground state to release the visible light, and a part of exciting energy is stored to release the visible light later. Therefore, the long-afterglow phosphor powder not only releases the visible light for illuminating at once, but also stores the exciting light source.

After the energy stored in the long-afterglow phosphor powder is saturated (the saturation time of storage relates to the material and thickness of the long-afterglow phosphor powder), the power source of the electrode sets 12 can be turned off, and the light energy absorbed by the long-afterglow phosphor powder is released in the form of visible light, so as to provide the illumination.

When the luminescence provided by the long-afterglow phosphor powder decreases to lowest brightness required, the power source 12 can be turned on again (the on/off of the power source 12 is controlled according to the experimental time value, or is controlled by disposing a light sensor beside the structures of fluorescent lamp 20, 30 to provide a signal to a controller), such that the required continuous luminance is provided, and the power supply time can be reduced, and thus the power is saved, the temperature of the structures of fluorescent lamp 20, 30 is reduced, and the luminescence efficiency of the passive luminous material is enhanced.

In addition, the structure of fluorescent lamp provided by the present invention combining the long-afterglow material and the sealed tube 21 can be used at night, in basements, or in office buildings that cannot be illuminated by sunshine. If the power is accidentally cut off, the excited long-afterglow material can keep emitting light that is visible for over 12 hours in darkness, the afterglow light can be used in emergency treatment or evacuation from the buildings, and additional emergency lamps are not required.

Moreover, for users who cannot fall asleep because of be afraid of the dark environment after the lamp is turned off, the luminance of the fluorescent lamp with the long-afterglow material decreases gradually after it is turned off. Thus the present invention can overcome the problem described above, and help to improve the quality of sleep. Therefore, in addition to reducing the power consumption (especially being applied to long-time illumination such as street lamps and advertisement signs), the structures of fluorescent lamp structures 20, 30 with the long-afterglow material of the present invention provide the functions of emergency and safety instructions when the power is accidentally cut off.

Since most damages of the fluorescent lamp occur at the filament electrodes of the sealed tube 21, when the lamp is out of order, only the sealed tube 21 needs to be replaced according to the structures of fluorescent lamp 20, 30 of the embodiments. The damaged sealed tube 21 can be recycled. A new sealed tube 21 can be fabricated by removing the electrode sets 12 of the sealed tube 21, recycling the residual mercury, cleaning, replacing new electrode sets 12, combining the electrode sets 12 and the glass tube, evacuating, charging inert gases and appropriate amount of mercury liquid droplets again, and sealing the air duct 211. Thus, the environmental problem caused by the mercury-containing phosphor powder in conventional waste fluorescent lamps can be largely reduced, and the raw material consumption of the glass, phosphor powder, and mercury, etc. of the sealed tube 21 is greatly reduced. Thus, a large amount of material resources can be saved.

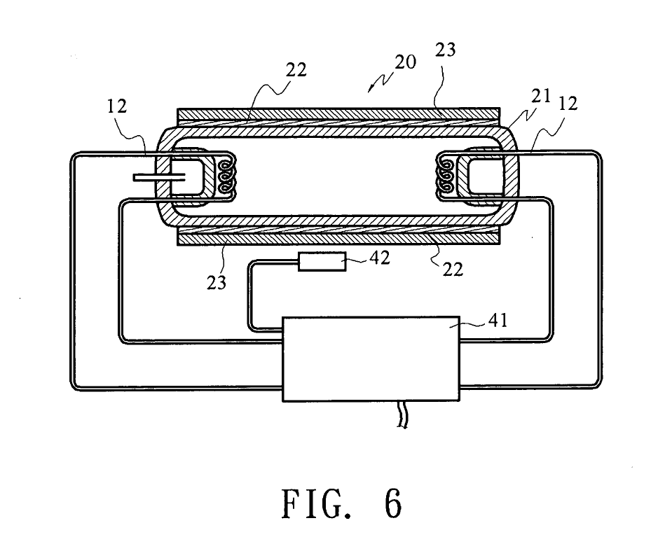

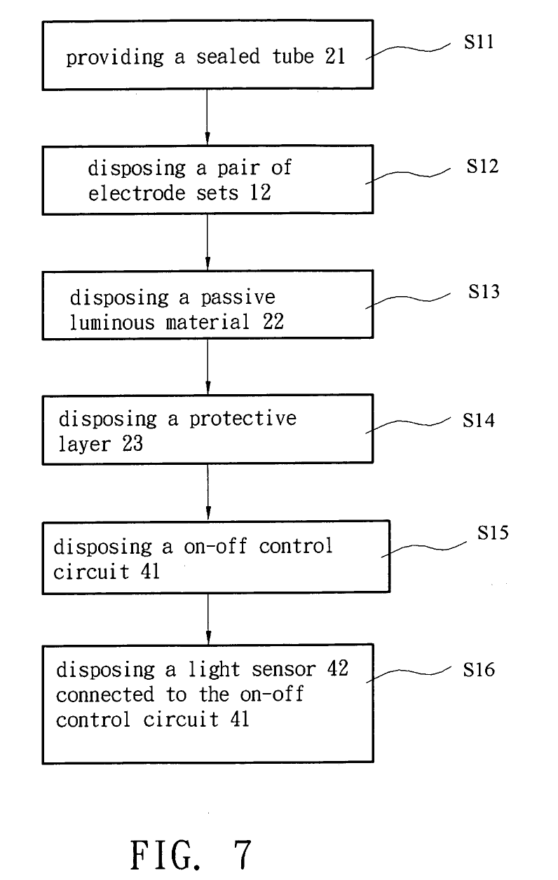

FIG. 6 is an application of the structures of fluorescent lamp 20, 30 using an on-off control circuit 41 and the light sensor 42 to perform the discontinuous control according to an embodiment of the present invention. FIG. 7 is the flow chart of the method for enabling the passive luminous material 22 to illuminate. This embodiment is a method for enabling the passive luminous material 22 to illuminate, which includes the following steps:

providing a sealed tube 21 (Step S11) filled with the glow discharge medium containing argon and mercury. The tube wall of the sealed tube 21 can be transmitted by the exciting light generated by glow discharge medium, and is made of a glass;

disposing a pair of electrode sets 12 (Step S12) on two ends of the sealed tube 21 and contacting the glow discharge medium;

disposing a passive luminous material 22 (Step S13) coated outside the sealed tube 21, in which the passive luminous material 22 is formed by a long-afterglow material, or a mixture of a short-afterglow material and a long-afterglow material, and furthermore, the passive luminous material 22 can be further mixed with an binder to facilitate the fabrication of a passive luminous body or facilitate the coating of the passive luminous material 22;

disposing a protective layer 23 (Step S14) coated on the passive luminous material 22, in which the protective layer 23 is formed by glass of low melting point or a organic polymer material;

disposing a on-off control circuit 41 (Step SI 5) between the pair of electrode sets 12 and a power source, in which as the passive luminous 22 keeps working for a period of time after absorbing the exciting light generated by glow discharge medium even if it doesn't absorb the light energy anymore, the operating time of the exciting light that is generated by exciting the glow discharge medium in the sealed tube 21 can be controlled by the on-off control circuit 41 through discontinuously supplying the power; and

disposing a light sensor 42 (Step S16) connected to the on-off control circuit 41, for detecting the luminous intensity of the passive luminous material 22, in which when the luminance of the passive luminous material 22 decays to a certain degree, the light sensor 42 provides signals to the on-off control circuit 41 to supply power for a period of time to excite the glow discharge medium in the sealed tube 21, such that the glow discharge medium in the sealed tube 21 releases light energy again which is absorbed by the passive luminous material 22. After the glow discharge medium in the sealed tube 21 emits the exciting light for a period of time, the power for engaging the glow-discharge of the glow-discharge medium is shut-off again by the on-off control circuit 41 again. The above-mentioned procedures are repeatedly operated.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A structure of a fluorescent lamp, comprising:
a sealed tube filled with a glow discharge medium, wherein a wall of the sealed tube can be transmitted by a glow-discharge light emitted by a electrical-glow-discharge of the glow discharge medium;
at least a pair of electrode sets assembled on two ends of the sealed tube, wherein the electrode sets are contacted with the glow discharge medium and provide an electrical power to generate the electrical-glow-discharge of the glow discharge medium for emitting a glow-discharge light;
at least a passive luminous material coated on an outer surface of the sealed tube to form a passive luminous layer, wherein the passive luminous layer absorbs the glow-discharge light emitted by the glow discharge medium to emit a luminous light with corresponding wavelength; and
at least a protective layer coated on the passive luminous layer, wherein the luminous light emitted by the passive luminous layer can transmit the protection layer.

2. The structure of a fluorescent lamp as claimed in claim 1, wherein the passive luminous layer has at least one layer, and the material of the passive luminous layer is selected from the groups consisting of a short-afterglow phosphor and a long-afterglow phosphor that emits a visible light by absorbing the glow-discharge light, wherein the long-afterglow phosphor is a material whose time period to decay the luminous intensity to 50% is longer than one minute after the absence of the glow-discharge light, and the short-afterglow phosphor is a material whose time period to decay the luminous intensity to 50% is shorter than one minute after the absence of the glow-discharge light.

3. The structure of a fluorescent lamp as claimed in claim 1, wherein the passive luminous layer has at least one layer, and the material of the passive luminous layer is selected from the groups consisting of an infrared-emitting material that emits infrared light by absorbing the glow-discharge light, a visible-emitting material that emits visible light by absorbing the glow-discharge light, and an ultraviolet-emitting material that emits the ultraviolet light by absorbing the glow-discharge light.

4. The structure of a fluorescent lamp as claimed in claim 1, wherein the material of the protective layer is selected from the groups consisting of oxide conductors, oxide nonconductors, glass, and polymers.

5. A structure of a fluorescent lamp, comprising:
a sealed tube filled with a glow discharge medium, wherein a wall of the sealed tube can be transmitted by a glow-discharge light emitted by a electrical-glow-discharge of the glow discharge medium;
at least a pair of electrode sets assembled on two ends of the sealed tube, wherein the electrode sets are contacted with the glow discharge medium and provide an electrical power to generate the electrical-glow-discharge of the glow discharge medium for emitting a glow-discharge light; and
at least a passive luminous body, which is disposed outside the sealed tube, wherein the passive luminous body absorbs the glow-discharge light to emit a luminous light with corresponding wavelength.

6. The structure of a fluorescent lamp as claimed in claim 5, wherein the passive luminous body comprises:
a supporting body; and
a passive luminous material coated on the surface of the supporting body.

7. The structure of a fluorescent lamp as claimed in claim 6, wherein the passive luminous layer has at least one layer, and the passive luminous material is selected from the groups consisting of a short-afterglow phosphor and a long-afterglow phosphor that emits a visible light by absorbing the glow-discharge light, wherein the long-afterglow phosphor is a material whose time period to decay the luminous intensity to 50% is longer than one minute after the absence of the glow-discharge light, and the short-afterglow phosphor is a material whose time period to decay the luminous intensity to 50% is shorter than one minute after the absence of the glow-discharge light.

8. The structure of a fluorescent lamp as claimed in claim 6, wherein the passive luminous layer has at least one layer, and the passive luminous material is selected from the groups consisting of an infrared-emitting material that emits infrared light by absorbing the glow-discharge light, a visible-emitting material that emits visible light by absorbing the glow-discharge, and an ultraviolet-emitting material that emits the ultraviolet light by absorbing the glow-discharge light.

9. The structure of a fluorescent lamp as claimed in claim 5, wherein the passive luminous body is formed by sintering the passive luminous material.

10. The structure of a fluorescent lamp as claimed in claim 9, wherein the passive luminous body has at least one luminous layer, and the passive luminous material is selected the groups consisting of a short-afterglow phosphor and a long-afterglow phosphor that emits a visible light by absorbing the glow-discharge light, wherein the long-afterglow phosphor is a material whose time period to decay the luminous intensity to 50% is longer than one minute after the absence of the glow-discharge light, and the short afterglow phosphor is a material whose time period to decay the luminous intensity to 50% is shorter than one minute after the absence of the glow-discharge light.

11. The structure of a fluorescent lamp as claimed in claim 9, wherein the passive luminous body has at least one luminous layer, the passive luminous material is selected from the groups consisting of an infrared-emission material that emits infrared light by absorbing the glow-discharge light, a visible-emission material that emits visible light by absorbing the glow-discharge, and an ultraviolet-emission material that emits the ultraviolet light by absorbing the glow-discharge light.

12. The structure of a fluorescent lamp as claimed in claim 5, wherein at least a protective layer is coated on the passive luminous body.

13. The structure of a fluorescent lamp as claimed in claim 12, wherein the material of the protective layer is selected from the groups consisting of oxide conductors, oxide nonconductors, glass, and polymers.

14. A structure of a fluorescent lamp, comprising:
a sealed tube filled with a glow discharge medium, wherein a wall of the sealed tube can be transmitted by a glow-discharge light emitted by a electrical-glow-discharge of the glow discharge medium;
at least a pair of electrode sets assembled on two ends of the sealed tube, wherein the electrode sets are contacted with the glow discharge medium, and provide an electrical power to generate the electrical-glow-discharge of the glow discharge medium for emitting a glow-discharge light;
at least a passive luminous material, which is disposed outside the sealed tube, wherein the passive luminous material absorbs the glow-discharge light to emit a luminous light of corresponding wavelength; and
an on-off control circuit connected between the pair of electrode sets and a power source for turning on and turning off the electrical power with a preset program.

15. The structure of a fluorescent lamp as claimed in claim 14, wherein a light sensor is connected to the on-off control circuit for controlling the electrical power supplied to the electrode sets by detecting the luminous intensity of the phosphor.
